(19) United States
(12) Patent Application Publication
(10) Pub. No.: US 2007/0019295 A1
(43) Pub. Date: Jan. 25, 2007

(54) Disk-shaped carrier system with a plurality of integrated diffraction structures

(76) Inventors: Andreas Mitreiter, Kleinmachnow (DE); Clemens Hanschke, Berlin (DE)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(21) Appl. No.: 11/485,163

(22) Filed: Jul. 12, 2006

(30) Foreign Application Priority Data
Jul. 12, 2005 (DE) 10 2005 033 852.6

(51) Int. Cl. G02B 5/18; G02B 27/44

(52) U.S. Cl. 359/566

(57) ABSTRACT

The invention concerns a circular disk-shaped carrier system with a plurality of integrated diffraction structures for the spectral analysis of light of the wavelengths 340-800 nm, wherein each diffraction structure includes a layer of a transparent plastic material which has a microstructure suitable for the diffraction of a wavelength within the wavelength spectrum of the light, and the carrier system includes at least two diffraction structures for the diffraction of light of differing wavelength.

### FIELD OF THE INVENTION

The invention concerns a disk-shaped carrier system with a plurality of integrated diffraction structures for the spectral analysis of light of the wavelengths 340-800 nm. The invention further concerns a process for the production of such carrier systems as well as a photometer which is designed to operate with such a carrier system.

### BACKGROUND OF THE INVENTION

Diffraction structures for optical devices, frequently implemented in the form of diffraction gratings, are sufficiently known from the state of the art and are generally produced from glass, which however is expensive. Diffraction gratings of plastic material are also known, which are usually produced by embossing processes using a glass or metal master mold. Thus for example H. Dislich, E. Hildebrandt: “Method of Production of Diffraction Gratings from Plastics with Inhibited Thermal Expansion”, Optik 1968, pages 126-131 discloses producing plastic diffraction gratings with a low thermal coefficient of expansion by polymerization on a master of glass or glass ceramic. That method is complicated and expensive and furnishes thin, mechanically unstable grating films.

DE 43 40 103 A1, DE 43 40 106 A1 and DE 43 40 107 A1 disclose processes for the production of structured concave diffraction gratings of plastic material and spectral photometers containing such diffraction gratings. The core concept of the processes described therein is the provision of a tool with which the concave diffraction grating can be produced by die casting or injection molding of the diffraction grating material. The diffraction grating can comprise epoxy resin, silicone material or a thermoplastic material.

A further process for the production of a passive optical device with echelette gratings is described in EP 0 242 574 B1. The process described in that document uses an X-ray lithographic technology for producing the grating lines of the echelette grating. A female tool is produced by an X-ray lithographic-galvanoplastic procedure, the structure of the tool having the negatives of the optical devices to be produced and the optical device being produced thereon by shaping with a transparent plastic material.

DE 197 13 483 A1 discloses a spectrometer for determining the emission spectrum of a light source or the absorption or reflection spectrum of a sample arranged in the beam path of the light source, in which there is a diffraction grating for diffraction of a wavelength which is within the emission spectrum of the light source. The diffraction grating is displaceable in parallel relationship with the plane of the grating or is rotatable about an axis of rotation arranged at a right angle to the plane of the grating or parallel to the grating lines of the diffraction grating. It has a grating constant which varies along the direction of movement. In an embodiment the diffraction grating is in the form of a rotatable circular disk which is divided into a plurality of circular segment-shaped regions, within each of which the respective grating constant is constant. In that situation the diffraction grating is formed by grating lines which, starting from the periphery of the circular disk, open in perpendicular relationship at the axis of rotation of the circular disk. In other words the grating lines are at a spacing from each other, which is dependent on the distance relative to the point of rotation, and are not arranged equidistantly. To effect measurement with another wavelength, the circular disk is rotated to such a degree that the light beam impinges on another segment of the circle.

The diffraction gratings of plastic material which are described in the state of the art are aimed at special uses. Hitherto, as far as the applicants are aware, there has not yet been large-scale use of plastic material-based diffraction gratings for the spectral analysis of light. The reason for that may be the relatively complicated and expensive production of the plastic material-based diffraction gratings which are generally only intended for a given wavelength and a given purpose of use. Conventional solutions involve difficulties in regard to a change in the diffraction grating arranged in the beam path of a photometer, for example in order to permit adjustment or calibration or in order to alter the wavelength of the diffracted light, or do not allow that in any way whatsoever by virtue of a fixed measuring arrangement.

### SUMMARY

The object of the invention is to simplify the use of plastic material-based diffraction structures and to provide a carrier system for a plurality of diffraction structures of differing wavelengths, that is to say with various grating constants.

The object is attained by a disk-shaped carrier system according to the invention. The invention involves the teaching of providing a circular disk-shaped carrier system having a plurality of integrated diffraction structures for the spectral analysis of light of the wavelengths 340-800 nm. In that case each diffraction structure includes a layer of a transparent plastic material having a microstructure which is suitable for the diffraction of a wavelength which is within the wavelength spectrum of the light. The carrier system further includes at least two diffraction structures for the diffraction of light of differing wavelength. The circular disk-shaped carrier system comprising a transparent plastic material can be inexpensively produced in large numbers. In many photometers the diffraction structures represent a factor which determines the total price and which can be markedly reduced by means of the carrier system according to the invention.

The layer of the transparent plastic material preferably comprises polymethylmethacrylate (PMMA). The advantages of the polymer lie in its favorable optical and mechanical properties as well as simple workability, in respect of which procedures can be based in particular on working processes which are established in the CD-production process. As an alternative thereto the layer of the transparent plastic material comprises polycarbonate (PC) or cycloolefin-copolymers (COC). In this case also the optical and mechanical properties of the polymers are favorable for the purpose of use according to the invention. The entire carrier system is preferably made from the same transparent plastic material which is also used in the diffraction structures.

Preferably the carrier system further corresponds in shape and dimensions to a CD or single CD. A CD of common kind is of a diameter of about 120 mm and a single CD is of a diameter of about 80 mm. CDs or single CDs are about 1.2 mm in thickness. The advantage of being based on the shape and dimensions of CDs or single CDs is inter alia that it is possible to have recourse to manufacturing technologies and associated manufacturing apparatuses. Furthermore a carrier system which is modified in that way can be particularly easily integrated into a photometer, that is to say the displaceable holder for the carrier system can be based in design on current holders for CDs or single CDs.

Preferably the individual diffraction structures are arranged radially in the periphery around a defined point of rotation of the carrier system. In that case the holder of the photometer centers the carrier system about that point of rotation so that a change in the diffraction structures in the beam path of the photometer can be achieved with a simple rotary movement. Preferably the diffraction structures are distributed equidistantly at precise angular relationships on the carrier system for that purpose.

The carrier system also preferably has one or more markings for determining a relative position of the individual diffraction structures on the carrier system. In that way it is possible to detect which diffraction structure is just disposed in the beam path of the photometer. If the individual diffraction structures are arranged radially in the periphery around a defined point of rotation of the carrier system, the marking preferably replaces a diffraction structure which is arranged radially in the periphery around the defined point of rotation of the carrier system. In this embodiment the marking and the diffraction structures are preferably distributed equidistantly on the carrier system in precise angular relationship. The carrier system does not have any diffraction structure in the region of the marking. The light beam which is not diffracted in the marking region is detected by a suitable detector in the photometer. The photometer delivers a signal which is dependent on the impingement or non-impingement of the light beam and which can be evaluated in per se known manner by means of a control system and which serves as an input value for determining the position of the diffraction structures.

It is further preferred if the individual diffraction structures each provide a beam cross-sectional area of dimensions of between 4×4 mm and 8×8 mm. In particular the individual diffraction structure are preferably of a circular configuration and the circles are of a diameter of between 7-9 mm.

The diffraction structure is preferably a refraction grating and provided on the microstructured layer is a reflection layer comprising a light-reflecting material, in particular aluminum. Preferably also a protective layer comprising a transparent plastic material, in particular a UV-hardening lacquer, can be applied to the reflection layer.

Alternatively the diffraction structure can also be a transmission grating. Transmission gratings have the advantage over reflection gratings that the diffracted light beam upon incorrect inclination of the plane of the grating with respect to the incident light beam is falsified only by the single angle of inclination, whereas the reflected light beam in the case of reflection gratings is falsified by double the angle of inclination. When using transmission gratings the demands in terms of precision of the spatial orientation of the diffraction structures and in particular the flatness of the carrier system are therefore lower than with reflection gratings.

The diffraction structures are preferably embodied in the form of diffraction gratings with a plurality of equidistant grating lines. A number of the grating lines as well as the shape and depth thereof determine the wavelength of the light which is diffracted in a predeterminable angle. The diffraction structure is preferably also embodied in the form of a flat diffraction grating. Diffraction structures with the above-mentioned features can be produced more easily in comparison with non-flat diffraction gratings and diffraction gratings with grating lines which are not equidistant.

In accordance with a second aspect of the invention a carrier system for diffraction structures having the aforementioned properties can be produced inexpensively and in large numbers insofar as the process includes the steps:
(i) producing a female die containing the negative of the diffraction structures,
(ii) receiving the female die in a mold tool,
   (a) heating a transparent plastic material by means of the mold tool and shaping the heated plastic material (hot embossing) or
   (b) injecting a melt comprising a transparent plastic material into a closed mold tool (injection molding) or
   (c) injecting a melt comprising a transparent plastic material into a mold tool which is not completely closed and closing the mold tool with shaping of the plastic material which is still molten (injection embossing).

Production of the female dies can be effected in the usual manner, in particular having recourse to the manufacturing technologies which are established in CD production. That includes for example the production of a glass master with a microstructured surface as a preliminary stage for the actual pressing tool, the stamper (metal CD blank). The microstructured surface is transferred by means of laser beam onto an especially coated glass plate, the subsequent glass master. Metalization and galvanization produce therefrom the stamper (female die) which is the starting point for the replication procedure. That process permits the production of diffraction structures with a relatively great grating constant.

For diffraction structures with a small grating constant, a different master production process must be used, as a departure from the CD technology. To produce the female die, firstly a quartz carrier coated with chromium is coated with a lacquer which is sensitive to electron radiation and a microstructure is written into the lacquer with an electron beam writer. By virtue of varying the subsequent development process of the exposed lacquer (for example by varying the development time and the temperature which prevails in the development procedure), a structure depth of the microstructure is set and a master for the female die is obtained. To produce the female die that master is shaped either galvanically, in particular with nickel, or with a casting resin, in particular epoxy resin. The female die is used as the original pattern for production of the mold tool.

A carrier system of that kind which is assembled on a circular disk, with a plurality of diffraction structures of differing spectral configuration, upon integration of the carrier system into a photometer, permits fast, inexpensive but still sufficiently accurate change in the wavelength diffracted at the structure, insofar as the desired diffraction structure is moved into the beam path of the optical measuring system. In accordance with a third aspect of the invention the photometer has means for receiving and integrating a carrier system having the above-described features in an optical system of the photometer. For that purpose the photometer preferably includes an adjustable holder for the carrier system which
(i) orients the carrier system in the photometer such that a diffraction structure of the carrier system is arranged in the beam path of the photometer, and
(ii) includes means which permits a change in the diffraction structure of the carrier system, which is in the beam path of the photometer.

The means for changing the diffraction structure in the beam path of the photometer include in particular a stepping motor which displaces the carrier system stepwise, for example by rotation, such that the diffraction structures which are integrated in the carrier system can be pivoted successively into the beam path.

### BRIEF DESCRIPTION OF THE DRAWINGS

The invention is described in greater detail hereinafter by means of embodiments by way of example and with reference to the accompanying drawings in which:

FIG. 1 shows a carrier system according to the invention in a first embodiment as a CD,

FIG. 2 shows a carrier system according to the invention in a second embodiment as a single CD,

FIG. 3 is a diagrammatic view of a photometer with a rotatable, circular disk-shaped carrier system,

FIGS. 4a and 4b are a plan view and a side view of a holder and an optical system as a component part of a photometer which is designed for receiving the carrier system,

FIG. 5 shows diagrammatic views of the beam path in a photometer with the optical system shown in FIGS. 4a and 4b, and

FIG. 6 is a photographic reproduction of a carrier system in the form of a CD.

### DETAILED DESCRIPTION

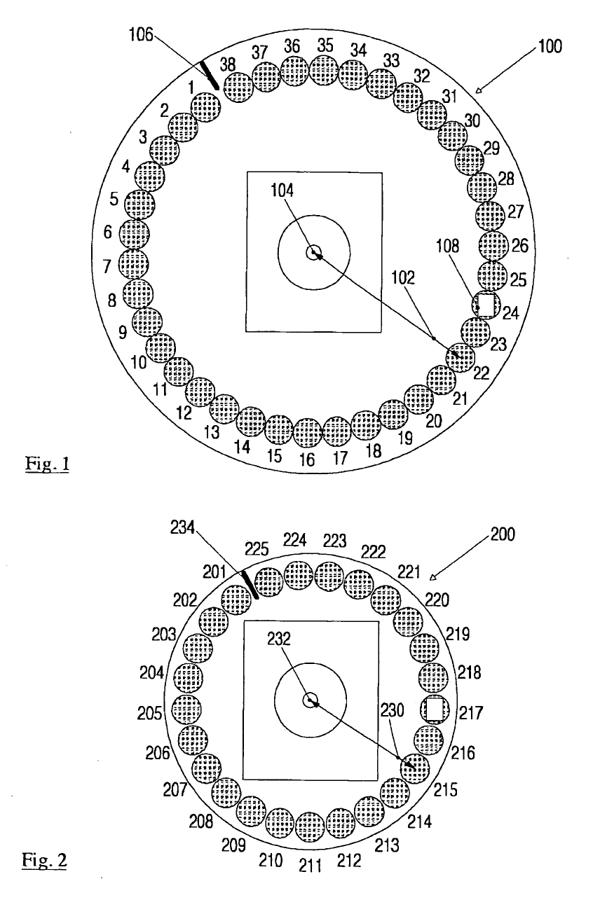

FIG. 1 shows a circular disk-shaped carrier system 100 in the form of and involving the dimensions of a commercially available CD, that is to say of a diameter of about 120 mm and a thickness of about 1.2 mm. The carrier system 100 is formed from the transparent plastic material polymethylmethacrylate (PMMA). At a radius 102 of 50 mm, a total of 38 diffraction structures, here embodied in the form of diffraction gratings 1-38, are arranged in a circle around a point of rotation 104 of the carrier system 100.

Provided at a position between the diffraction grating 1 and the diffraction grating 38 is a marking 106 which serves for recognition of the grating position, that is to say for recognition of the relative position of the individual diffraction gratings 1-38 on the carrier system 100. In this respect the marking 106 is so designed that it can be detected by a suitable recognition unit in the photometer into which the carrier system 100 is fitted. The diffraction gratings 1-38 themselves are distributed equidistantly in precise angular relationship on the carrier system 100 so that, from any single start position it is possible to go to each diffraction grating 1-38 over the same angular spacing. Therefore the start position of the carrier system 100 only has to be recognized once and the diffraction gratings 1-38 can then be approached over the angular differences.

The individual diffraction gratings 1-38 serve for the spectral analysis of light and are also formed from the transparent plastic material polymethylmethacrylate (PMMA). The regions of the diffraction gratings 1-38 of the carrier system 100 differ from the remaining portions of the carrier system 100 in that they have a microstructured surface with equidistant grating lines arranged in a common plane. The depth and geometry and also in particular the number of the grating lines of the diffraction gratings 1-38 differ in at least two of the diffraction gratings 1-38, that is to say they are respectively optimized for the diffraction of different wavelengths. In the present case all diffraction gratings 1-38 each have a respective mutually differing microstructure, more specifically in such a way that they diffract successively rising wavelengths over a spectral range of 340-800 nm (first-order diffraction). In that case each grating covers a spectral range of about 12 nm and the column width and linear dispersion are so predetermined that that value is attained. The individual diffraction gratings 1-38 can be calculated in known manner, that is to say the depth of the microstructure and in particular the number of the grating lines can be calculated in advance in order in a predetermined angle to obtain a light beam of given wavelength and intensity which is diffracted in accordance with the first order.

The present carrier system 100 is in the form of a transmission grating, that is to say the light beam enters approximately at 0° inclination relative to the surface normal of the diffraction gratings 1-38, is diffracted in accordance with the respective optical properties of the diffraction grating 1-38 and issues at the underside of the carrier system 100. It will be appreciated that it is also conceivable for the light to enter at a defined angle and for the diffracted light to be received for example at 0° inclination.

For calibration and functional checking purposes three diffraction gratings can be optimized at diffraction wavelengths of 361 nm. In addition a diffraction grating of the wavelength 633 nm in combination with a helium neon laser and a region on the carrier system without diffraction grating in order to recognize the precise angular position of the carrier system by detection of transmission is suitable for adjustment purposes. In that case it is possible to dispense with the marking 106 as is shown in the carrier system 100 in FIG. 1.

As already explained the diffraction gratings 1-38 are arranged radially in the periphery of the carrier system 100 at a radius of 50 mm. The individual diffraction gratings 1-38 are of a circular configuration in this case and are of a diameter of 8 mm. That can provide for example a beam cross-sectional area 108 of 6×4.5 mm.

If the present 38 diffraction gratings are designed for a spectral range of 360-700 nm, then each diffraction grating should cover a spectral range of about 8.9 nm.

FIG. 2 shows a carrier system 200 which in terms of its structure is very substantially the same as the carrier system 100 already shown in FIG. 1. In that respect reference is made to the foregoing description. Unlike the carrier system 100 in FIG. 1 the carrier system 200 is adapted in shape and dimensions to a single CD, that is to say it is of a diameter of about 80 mm and a thickness of about 1.2 mm. The diffraction gratings 201-225 are arranged at a radius 230 of about 34 mm about a point of rotation 232 of the carrier system 200. A marking 234 serves for recognition of the relative position of the diffraction gratings 201-225.

If the 25 gratings 201-225 of the carrier system 200 of FIG. 2 are intended to cover a spectral range of 340-800 nm, then each diffraction grating 201-225 should cover a spectral range of about 18.4 nm. If the total spectral range is limited to 360-700 nm then each diffraction grating 201-225 should cover a spectral range of about 13.6 nm.

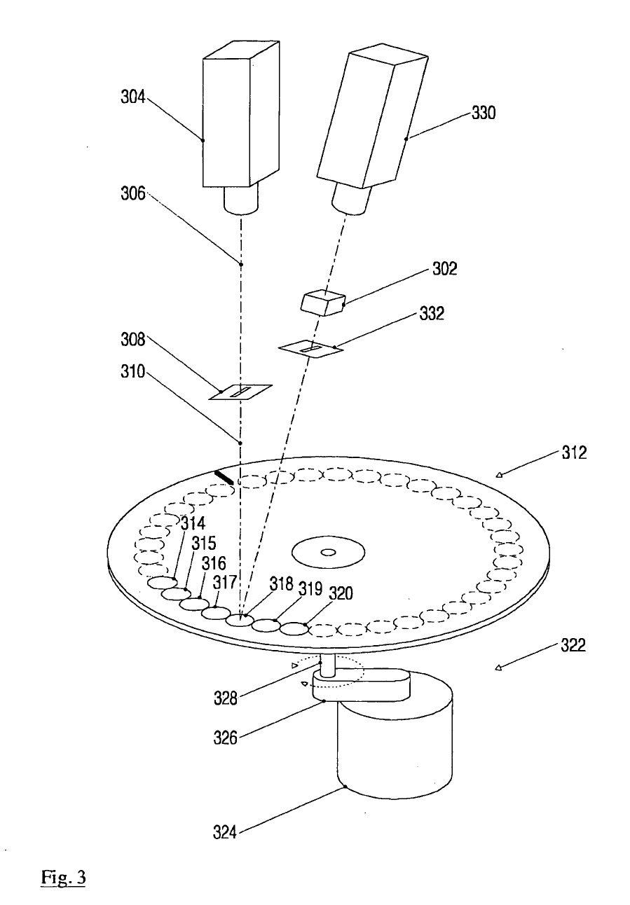

FIG. 3 shows a diagrammatic illustration of the structure of a photometer which uses a circular disk-shaped carrier system with a plurality of integrated flat diffraction gratings for the spectral analysis of light of the wavelengths 340-800 nm. To determine an absorption spectrum, a sample 302 is arranged in the beam path of a light source 304. The light source 304 emits a relatively widely fanned light beam and has a wide-band emission spectrum which completely covers the wavelength range which is of interest for absorption measurement. Arranged in the beam path is an aperture member 308 with a slot which cuts a narrowly limited light ray 310 out of the relatively widely fanned light beam 306 emitted by the light source 304. That aperture member 308 which is referred to as the entry slot is of determinative influence in regard to the spectral bandwidth of the photometer. It further determines the amount of light which passes through the system and for what beam dimension the further optical system must be design ed.

The carrier system 312 is adapted in shape and dimensions to a conventional CD. It has a plurality of integrated flat diffraction gratings 314-320 arranged in the periphery of the circular disk-shaped carrier system 312. The carrier system 312 comprises polycarbonate and in the region of the diffraction gratings 314-320 has a suitable microstructuring with grating lines in order to diffract and reflect the light beam 310, the reflected beam being of a predetermined wavelength. In the present case the diffraction gratings 314-320 are in the form of reflection gratings. For that purpose a reflection layer comprising a material which reflects in the wavelength range of the light is applied to the microstructured first layer of the diffraction gratings 314-320 (this is not shown in greater detail). In the present case the reflection layer comprises aluminum. A protective layer of a transparent plastic material, in particular a UV-hardening lacquer, is applied to that reflection layer for stabilization purposes.

The carrier system 312 is supported in a releasable holder 322 of the photometer. With the holder 322, the diffraction gratings 314-320 can be arranged exactly in the beam path of the photometer. The holder 322 further includes a stepping motor 324 which permits a change in the diffraction grating 314-320 which is disposed in the beam path of the photometer, by way of a transmission 326 and a shaft 328. Accordingly the carrier system 312 is rotated by means of the stepping motor 324. The carrier system 312 is rotated into different positions during the measurement procedure, the light beam 310 impinging on a different diffraction grating 314-320 in each position.

An intensity of the diffracted first-order light which has passed through the sample 302 is detected. Accordingly, a first-order diffraction maximum is produced by virtue of diffraction at the reflection gratings 314-320 at a given angle relative to the incident light beam 310, the intensity of the diffraction maximum being detected by a light detector 330, while a further aperture member 332 with a slot is arranged in the beam path between the diffraction grating 314-320 and the light detector 330 in order to achieve angle separation of the light detector 330, which is as good as possible, and to very substantially cut out the influence of interference light.

The diffraction angle and thus the spatial position of the first-order diffraction maximum is dependent on the one hand on the grating constant of the diffraction grating 314-320 and on the other hand on the wavelength of the incident light beam 310 so that the diffraction grating 314-320 has a spectral-analysis action and the light detector 330 respectively measures only the intensity of a spectral component of a given wavelength. To measure the intensity of a given wavelength, the corresponding diffraction grating 314-320 is rotated into the beam path by means of the stepping motor 324.

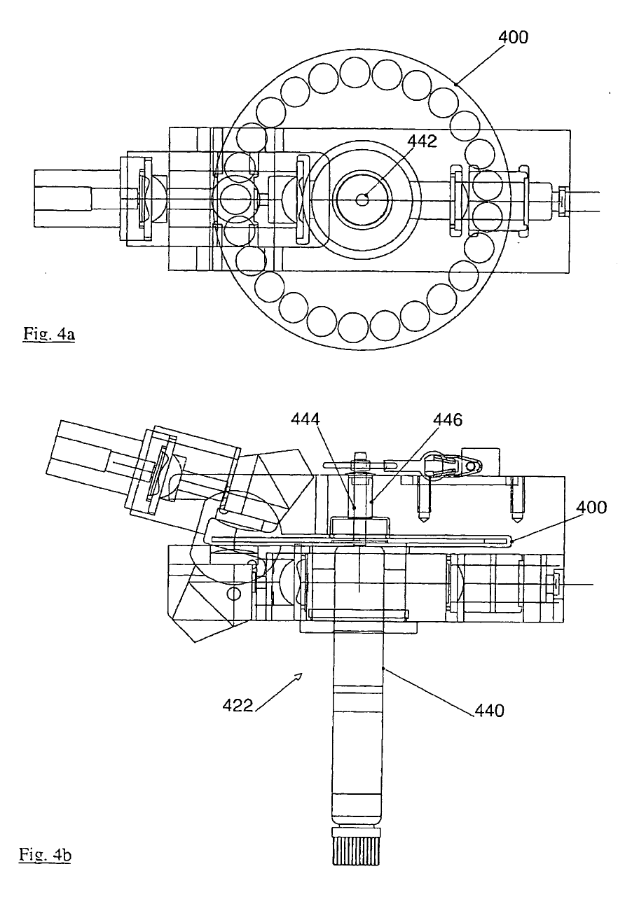

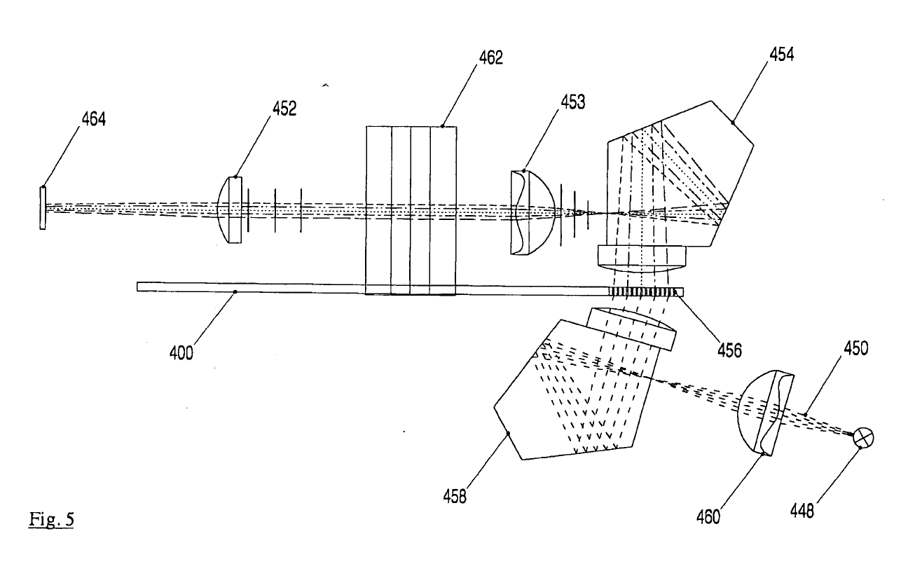

FIGS. 4a and 4b are a plan view and a side view of a technical drawing of a holder 422 and parts of an optical system as a component part of a photometer which is designed to receive the carrier system 400. As will be seen the carrier system 400 which is in the form of a CD is supported on a shaft 440 which can be caused to rotate by a stepping motor (not shown here). The carrier system 400 centrally has a region which is especially shaped for mounting on the shaft 440 and which inter alia includes a bore 442. A pin 444 engages through the bore 442, the pin constituting a component of a lock portion 446 of the holder 422, which fixes the carrier system 400 to the shaft 440 in a defined position.

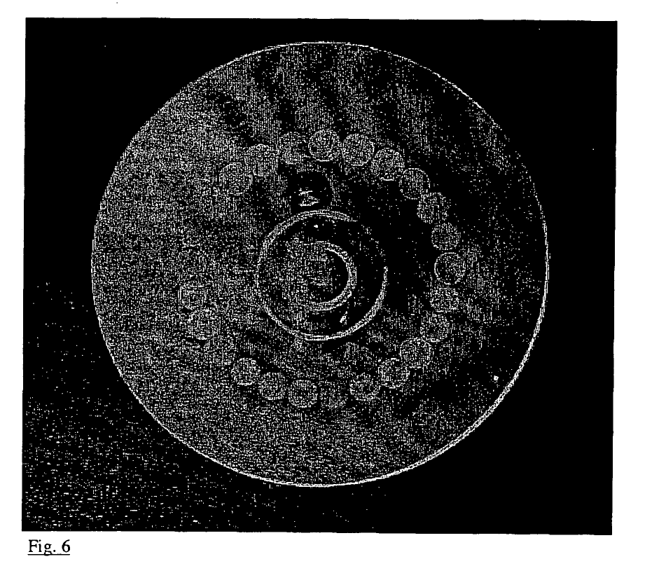

FIG. 5 illustrates the beam path in a photometer with an optical system, as is shown in FIGS. 4a and 4b. A light beam 450 is emitted from a light source 448 and deflected with optical elements 458 arranged in the beam path beneath the carrier system 400 onto a diffraction grating 456 which is integrated in the carrier system 400 (more precisely, the beam cross-sectional area of the diffraction grating 456). The light beam 450 passes through the diffraction grating 456 and is subjected to first-order diffraction, as illustrated. It is deflected by means of further optical elements 454 and 453 and focused onto a sample 462 shown here. The light beam 450 is then projected onto the receiver 464 by means of a lens 452.

FIG. 6 shows a photograph of a carrier system produced from polymethylmethacrylate (PMMA) with diffraction gratings arranged radially at the periphery.

Accordingly the carrier system makes it possible to produce diffraction gratings in a composite assembly, which also have a beam-shaping function and which can be used in Fresnel lenses or for diffractive beam shaping.

Production of the carrier systems can be effected by having recourse to known CD manufacturing processes. For that purpose firstly a female die is produced in known manner, which at its surface has microstructures which represent a negative of the microstructures of the subsequent diffraction gratings. The actual manufacturing procedure can be implemented by hot embossing, injection molding or injection embossing of the transparent plastic material. In the hot embossing procedure the female die is used to produce an embossing punch as a mold tool, by way of which the plastic substrate is heated, with the heated plastic material then being shaped. In the injection molding procedure the female die is part of a closed mold tool and a molten plastic material is injected into that closed tool. In injection embossing the female die is once again a component part of a mold tool, but the tool is not completely closed upon injection of the molten plastic material and is closed only after the material has been injected, with the material while still in a molten condition being shaped. If the diffraction gratings are to serve as reflection gratings, then in a subsequent step a reflection layer of aluminum is produced by vapor deposition. The microstructure can then also be protected from environmental influences by a protective layer of a polymeric lacquer.

1. A circular disk-shaped carrier system (100, 200, 312, 400) with a plurality of integrated diffraction structures (1-38, 201-225, 314-320) for the spectral analysis of light of the wavelengths 340-800 nm, wherein each diffraction structure (1-38, 201-225, 314-320) includes a layer of a transparent plastic material which has a microstructure suitable for the diffraction of a wavelength within the wavelength spectrum of the light, and the carrier system (100, 200, 312, 400) includes at least two diffraction structures (1-38, 201-225, 314-320) for the diffraction of light of differing wavelength.

2. A carrier system as set forth in claim 1 in which the layer comprises polymethylmethacrylate (PMMA).

3. A carrier system as set forth in claim 1 in which the layer comprises polycarbonate (PC) or cycloolefin copolymers (COC).

4. A carrier system as set forth in claim 1 in which the carrier system (100, 200, 312, 400) corresponds in shape and dimensions to a CD or single CD.

5. A carrier system as set forth in claim 1 in which the diffraction structures (1-38, 201-225, 314-320) are arranged radially at the periphery around a defined point of rotation (104, 232) of the carrier system (100, 200, 312, 400).

6. A carrier system as set forth in claim 5 in which the diffraction structures (1-38, 201-225, 314-320) are distributed in precise angular equidistant relationship on the carrier system (100, 200, 312, 400).

7. A carrier system set forth in claim 1 in which the carrier system (100, 200, 312, 400) has one or more markings (106) for determining a relative position of the individual diffraction structures (1-38, 201-225, 314-320) on the carrier system (100, 200, 312, 400).

8. A carrier system as set forth in claim 5 in which the marking (106) replaces a diffraction structure (1-38, 201-225, 314-320) which is arranged radially at the periphery around a defined point of rotation (104, 232) of the carrier system (100, 200, 312, 400).

9. A carrier system as set forth in claim 8 in which the marking (106) and the diffraction structures (1-38, 201-225, 314-320) are distributed in precise angular equidistant relationship on the carrier system (100, 200, 312, 400).

10. A carrier system as set forth in claim 1 in which the individual diffraction structures (1-38, 201-225, 314-320) are circular and the circles are of a diameter of between 7 and 9 mm.

11. A carrier system as set forth in claim 1 in which the individual diffraction structures (1-38, 201-225, 314-320) each provide a respective beam cross-sectional area of dimensions of between 4×4 mm to 8×8 mm.

12. A carrier system as set forth in claim 1 in which the diffraction structure (1-38, 201-225, 314-320) is a transmission grating.

13. A carrier system as set forth in claim 1 in which the diffraction structure (1-38, 201-225, 314-320) is a reflection grating and a reflection layer comprising a light-reflecting material is applied to the microstructured layer.

14. A carrier system as set forth in claim 13 in which the reflection layer comprises aluminum.

15. A carrier system as set forth in claim 14 in which a protective layer of a transparent plastic material is applied to the reflection layer.

16. A carrier system as set forth in claim 15 in which the protective layer comprises a UV-hardening lacquer.

17. A carrier system as set forth in claim 1 in which the diffraction structure (1-38, 201-225, 314-320) is a diffraction grating with equidistant grating lines.

18. A carrier system as set forth in claim 17 in which the diffraction structure (1-38, 201-225, 314-320) is a flat diffraction grating.

19. A process for the production of a circular disk-shaped carrier system as set forth in claim 1 including the steps:
(i) producing a female die containing the negative of the diffraction structures (1-38, 201-225, 314-320),
(ii) receiving the female die in a mold tool,
(a) heating a transparent plastic material by means of the mold tool and shaping the heated plastic material (hot embossing) or
(b) injecting a melt comprising a transparent plastic material into a closed mold tool (injection molding) or
(c) injecting a melt comprising a transparent plastic material into a mold tool which is not completely closed and closing the mold tool with shaping of the plastic material which is still molten (injection embossing).

20. A process as set forth in claim 19 in which to produce the female die a quartz carrier coated with chromium is coated with a lacquer which is sensitive to electron radiation and a microstructure is light-written into the lacquer with an electron beam writer.

21. A process as set forth in claim 20 in which by varying the subsequent development process of the exposed lacquer a structure depth in respect of the microstructure is set and a master for the female die is obtained.

22. A process as set forth in claim 21 in which to produce the female die the master is shaped either galvanically, in particular with nickel, or with a casting resin, in particular epoxy resin.

23. A photometer comprising means for receiving and integrating a carrier system (100, 200, 312, 400) as set forth in claim 1 into an optical system of the photometer.

24. A photometer as set forth in claim 23 characterized in that there is provided a releasable holder for the carrier system (100, 200, 312, 400), which
(i) orients the carrier system (100, 200, 312, 400) in the photometer such that a diffraction structure (1-38, 201-225, 314-320) of the carrier system is arranged in the beam path of the photometer, and
(ii) includes means which permits a change in the diffraction structure (1-38, 201-225, 314-320) of the carrier system (100, 200, 312, 400), which is in the beam path of the photometer.
